(19) United States
(12) Patent Application Publication
(10) Pub. No.: US 2024/0343997 A1
(43) Pub. Date: Oct. 17, 2024

(54) FABRIC CONDITIONER COMPOSITION

(71) Applicant: Conopco, Inc., d/b/a UNILEVER, Englewood Cliffs, NJ (US)

(72) Inventors: Olivier BACK, Lyon (FR); Christopher BOARDMAN, Llandyrnog (GB)

(73) Assignee: Conopco, Inc., d/b/a UNILEVER, Englewood Cliffs, NJ (US)

(21) Appl. No.: 18/580,349

(22) PCT Filed: Jul. 8, 2022
(86) PCT No.: PCT/EP2022/069081

§ 371 Date: Jan. 18, 2024

(30) Foreign Application Priority Data
Jul. 20, 2021 (EP) 21306023.9

(51) Int. Cl. C11D 3/00; C11D 1/62

(52) U.S. Cl. CPC C11D 3/0015; C11D 1/62

(57) ABSTRACT

A fabric conditioner composition comprising a mixture of compounds having the formula (I) wherein each R group, is independently selected from a C₁₅ or C₁₇ aliphatic group, Y is a divalent C₁-C₆ aliphatic group, R′, R″ and R′″ are independently selected from hydrogen 5 or a C₁ to C₄ alkyl group, Xⁿ⁻ is a counter-anion, n is an integer which is equal to 1, 2 or 3, depending on the nature of the counter-anion and said mixture comprising from 20 to 95% mol of compounds of formula I wherein both R are both C₁₅ aliphatic groups.

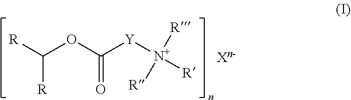

### FIELD OF THE INVENTION

The present invention relates to fabric conditioners comprising mixtures of ammonium compounds, in particular quaternary ammonium compounds derivable from internal ketones, themselves obtainable from mixtures of fatty acids or their derivatives.

### BACKGROUND OF THE INVENTION

Fabric conditioners traditionally comprise quaternary ammonium compounds to provide softening to fabrics. In particular ester linked quaternary ammonium compounds derived from triethanolamine are commonly used. However there is a need to find fabric softening actives with improved weight efficient softening and which are biodegradable.

### SUMMARY OF THE INVENTION

It has been found that the fabric softening actives described herein provide weight efficient softening and biodegradability.

Accordingly in one aspect of the present invention is provided a fabric conditioner composition comprising:
a) a mixture of compounds having the formula I:

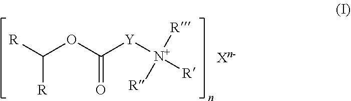

wherein each R group, is independently selected from a C₁₅ or C₁₇ aliphatic group,
Y is a divalent C₁-C₆ aliphatic group,
R′, R″ and R′″ are independently selected from hydrogen or a C₁ to C₄ alkyl group,
Xⁿ⁻ is a counter-anion selected from the group consisting of:
   i. a halide (n=1),
   ii. a hydrocarbylsulfate anion of formula R^{a}—O—SO₂—O⁻ wherein R^{a} denotes a C₁-C₂₀ hydrocarbyl group which can be optionally halogenated (n=1),
   iii. a hydrocarbylsulfonate anion of formula R^{a}—SO₂—O⁻ wherein R^{a} denotes a C₁-C₂₀ hydrocarbyl group which can be optionally halogenated (n=1),
   iv. a sulfate anion of formula SO₄²⁻ (n=2)
   v. a hydrogensulfate (or bisulfate) anion of formula HSO₄⁻ (n=1),
   vi. a carbonate anion of formula CO₃²⁻ (n=2)
   vii. a hydrogencarbonate (or bicarbonate) anion of formula HCO₃⁻ (n=1)
   viii. a dihydrogenphosphate anion of formula H₂PO₄⁻ (n=1)
   ix. a hydrogenphosphate anion of formula HPO₄²⁻ (n=2)
   x. a phosphate anion of formula PO₄³⁻ (n=3)
   xi. an organic carboxylate anion of formula Rₐ—CO₂— wherein Ra denotes a C1-C20 hydrocarbyl group which can be optionally halogenated substituted by a heteroatom containing group (n=1),
   xii. and mixtures thereof,
n is an integer which is equal to 1, 2 or 3, depending on the nature of the counter-anion and
said mixture comprising from 20 to 95% mol of compounds of formula I wherein both R are C₁₅ aliphatic groups.

The invention further relates to a method of softening fabrics, wherein a fabric conditioner as described herein is added to the rinse stage of laundering said fabrics.

The invention additionally relates to a use of the fabric conditioners as described herein to provide softening to fabrics.

### DETAILED DESCRIPTION

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

The fabric conditioners described herein comprise a mixture of compounds having the formula I:

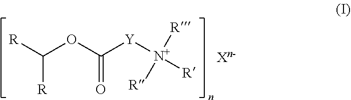

wherein each R group, is independently selected from a C₁₅ or C₁₇ aliphatic group, Y is a divalent C₁-C₆ aliphatic group,
R′, R″ and R′″ are independently selected from hydrogen or a C₁ to C₄ alkyl group,
Xⁿ⁻ is a counter-anion selected from the group consisting of:
   i. a halide (n=1),
   ii. a hydrocarbylsulfate anion of formula R^{a}—O—SO₂—O⁻ wherein R^{a} denotes a C₁-C₂₀ hydrocarbyl group which can be optionally halogenated (n=1),
   iii. a hydrocarbylsulfonate anion of formula R^{a}—SO₂—O⁻ wherein R^{a} denotes a C₁-C₂₀ hydrocarbyl group which can be optionally halogenated (n=1),
   iv. a sulfate anion of formula SO₄²⁻ (n=2)
   v. a hydrogensulfate (or bisulfate) anion of formula HSO₄⁻ (n=1),
   vi. a carbonate anion of formula CO₃²⁻ (n=2)
   vii. a hydrogencarbonate (or bicarbonate) anion of formula HCO₃⁻ (n=1)
   viii. a dihydrogenphosphate anion of formula H₂PO₄⁻ (n=1)
   ix. a hydrogenphosphate anion of formula HPO₄²⁻ (n=2)
   x. a phosphate anion of formula PO₄³⁻ (n=3)
   xi. an organic carboxylate anion of formula Rₐ—CO₂— wherein R^{a} denotes a C1-C20 hydrocarbyl group which can be optionally halogenated substituted by a heteroatom containing group (n=1),
   xii. and mixtures thereof,
n is an integer which is equal to 1, 2 or 3, depending on the nature of the counter-anion and
said mixture comprising from 20 to 95% mol of compounds of formula I wherein both R are C₁₅ aliphatic groups.

The aliphatic groups R may be free of any double bond and of any triple bond. Alternatively, the aliphatic groups R may comprise at least one —C═C— double bond and/or at least one —C≡C— triple bond.

The aliphatic groups R are advantageously chosen from alkyl groups, alkenyl groups, alkanedienyl groups, alkanetrienyl groups and alkynyl groups.

The aliphatic groups R may be linear or branched.

Preferably, the aliphatic groups R are independently chosen from alkyl and alkenyl groups.

More preferably, the aliphatic groups R are independently chosen from linear alkyl and alkenyl groups.

Acyclic aliphatic groups, more preferably linear aliphatic groups, still more preferably linear alkyl groups may be mentioned as preferred examples of substituents R. Excellent softening and biodegradability results were obtained when R were linear alkyl groups.

R′ is preferably a C₁ to C₄ alkyl group, preferably methyl or ethyl, more preferably methyl. Likewise, R″ is preferably a C₁ to C₄ alkyl group, preferably methyl or ethyl, more preferably methyl. Still likewise, R′″ is preferably a C₁ to C₄ alkyl group, preferably methyl or ethyl, more preferably methyl. Preferably at least one, more preferably at least two, more preferably all three of R′, R″ and R′″ are a C₁ to C₄ alkyl group, preferably methyl or ethyl, most preferably methyl.

Y is preferably an acyclic divalent C₁-C₄ aliphatic group, more preferably a saturated acyclic divalent C₁-C₆ aliphatic group, still more preferably a linear alkanediyl (commonly referred to as “alkylene”) C₁-C₆ group. Besides, Y has preferably from 1 to 4 carbon atoms. Exemplary Y are: methanediyl (commonly referred to as “methylene”), ethane-1.2-diyl (commonly referred to as “ethylene”) and ethane-1,1-diyl. Excellent results were obtained when Y was a methylene group.

Suitable Xⁿ⁻ are halides such as chloride, fluoride, bromide or iodide, methyl sulfate or methosulfate anion (CH₃—OSO₃⁻), methanesulfonate anion (CH₃—SO₃⁻), sulfate anion, hydrogensulfate anion (HSO₄⁻), carbonate anion, bicarbonate anion (HCO₃⁻), dihydrogenphosphate anion (H₂PO₄²⁻), hydrogenphosphate anion (HPO₄²⁻), phosphate anion or an organic carboxylate anion such as acetate, propionate, benzoate, tartrate, citrate, lactate, maleate or succinate.

According to one preferred embodiment, Xⁿ⁻ is a halide, preferably chloride, with n=1.

In the mixture according to the invention, it is advantageous that R groups are C₁₅ or C₁₇ alkyl groups and that the mixture comprises from 20 to 95% mol of compounds of formula I wherein both R groups are C₁₅ alkyl groups.

The best softening and biodegradability results are obtained when the mixture according to the invention is such as R groups are C₁₅ or C₁₇ linear alkyl groups and said mixture comprises from 20 to 95% mol of compounds of formula I wherein both R groups are C₁₅ linear alkyl groups.

In the mixture according to the invention, excellent softening and biodegradability results are obtained when the mixture comprises from 20 to 60% mol, preferably 30 to 50% mol of compounds of formula I wherein both R groups are C₁₅ aliphatic groups, preferably alkyl groups and notably linear alkyl groups.

According to a preferred embodiment, the mixture according to the invention comprises:
from 20 to 95% mol of compounds of formula I wherein both R groups are C15 linear alkyl groups, preferably from 20 to 60% mol, more preferably from 30 to 50% mol,
from 4.9 to 50% mol of compounds of formula I wherein one R group is a C15 linear alkyl group and the other R group is a C17 linear alkyl preferably from 35 to 50% mol, more preferably from 41 to 50% mol and
from 0.1 to 31% mol of compounds of formula I wherein both R groups are C17 linear alkyl groups preferably from 5 to 31% mol, more preferably from 9 to 20% mol.

The mixture according to the invention can further comprise less than 5% mol of compounds of formula I wherein R groups, which are independently selected from C₇ to C₁₃ aliphatic groups, preferably less than 2% mol. Those products are by-products that come from the raw materials used. Indeed, when the fatty acid cut used as starting material contains low quantities of one or more fatty acid(s) based on C₇ to C₁₃ aliphatic groups, all the possible internal ketones that can be obtained by the coupling of any of the one or more fatty acid(s) based on C₇ to C₁₃ aliphatic group with any fatty acid contained in the cut are produced during the step of decarboxylative ketonization.

The mixture according to the invention can further comprise less than 5% mol of compounds of formula I wherein R groups, which are independently selected from C₁₉ to C₂₁ aliphatic groups, preferably less than 2% mol. Those products are by-products that come from the raw materials used. As previous explained, when the fatty acid cut used as starting material contains low quantities of one or more fatty acid(s) based on C₁₉ to C₂₁ aliphatic groups, all the possible internal ketones that can be obtained by the coupling of any of the one or more fatty acid(s) based on C₁₉ to C₂₁ aliphatic groups with any fatty acid contained in the cut are produced during the step of decarboxylative ketonization (see step a. below in the description).

According to a particular embodiment of the invention, the mixture of compounds of formula I does essentially contain compounds of formula I wherein R groups, which are independently selected from C₁₅ or C₁₇ linear alkyl groups. It means that other compounds are representing less than 2% mol, preferably less than 1% mol.

The above defined mixture provides good softening and good biodegradability. In the experiments below, it is demonstrated that by a careful control of the hydrocarbon average chain length (R—CH—R) (notably through the careful choice of the starting fatty acid) a balance between softening and biodegradability can be achieved. For example, starting from a C₁₆:C₁₈ fatty acid mixture, a minimal amount of C₁₆ is necessary in the starting fatty acid to achieve readily biodegradation for the final compound.

The mixture of compounds of formula I in accordance with the present invention can be obtained by a variety of processes. Preferred processes for the manufacture of the compounds of the present invention include the reaction of an internal ketone of formula II:

R—C(═O)—R (II),

which internal ketone may preferably be obtained by decarboxylative ketonization of a mixture of fatty acids, fatty acid derivatives or a mixture thereof. A suitable process for the manufacture of internal ketones following this route is disclosed in US 2018/0093936 to which reference is made for further details.

A mixture of compounds of formula I as defined above is advantageously obtained through a process starting from a mixture of fatty acids R—COOH, wherein R is a C₁₅ or C₁₇ aliphatic group and said mixture of fatty acids comprising from 45 to 98% mol of R—COOH wherein R is a C₁₅ aliphatic group.

It is particularly preferred that said process is starting from a mixture of fatty acids R—COOH, wherein R is a C₁₅ or C₁₇ linear alkyl group and said mixture of fatty acids comprising from 45 to 78% mol, more preferably from 55 to 71% mol of R—COOH wherein R is a C₁₅ linear alkyl group.

The process of the obtaining mixed compounds are described herein can be a process including: 1) Piria ketonization (or decarboxylative ketonization) of a mixture of fatty acids described above, 2) Ketone hydrogenation to a mixture of secondary fatty alcohols, 3) Alcohol esterification, notably with chloroacetic acid (in the case Y is methylene), 4) Condensation of the mixture of monoesters, notably chloroesters with an amine, 5) Optionally anion exchange to afford the desired quaternary ammonium mixture of compounds of formula I.

The process starts with a Piria ketonization followed by hydrogenation, and esterification to obtain a mixture of monoesters. The esterification reaction step is followed by an amine condensation step to convert the monoester into a mixture of compounds that can comply with formula I or that can be further reacted through an anion exchange reaction to comply with formula I. This is a multi-step process plugged on Piria technology. It has the advantage of being salt-free when no step of anion exchange is performed and relying on chemical transformations which can be easily performed.

The process for producing a mixture of fabric softening compounds as described herein can comprise the following steps:
a. decarboxylative ketonization of a mixture of fatty acids R—COOH, wherein R is a C₁₅ or C₁₇ aliphatic group and wherein said mixture of fatty acids comprising from 45 to 98% mol of R—COOH with R being a C₁₅ aliphatic group, in presence of a metal catalyst thus obtaining a mixture of internal ketones of formula II:

R—C(═O)—R (II),
wherein R groups are as defined above,
b. Hydrogenation of the mixture of internal ketones of formula II obtained at step a. in presence of H₂ and a catalyst thus obtaining a mixture of secondary alcohols of formula III:

R—CH(OH)—R (III),
wherein R groups are as defined above,
c. Esterification of the mixture of secondary alcohols of formula III obtained at step
b. with a carboxylic acid reagent of formula IV:

[L-Y—CO₂H]^{(t-1)-}[U^{u+}]_{(t-1)/u} (IV)
wherein L is a leaving group,
t is an integer which is equal to 1 or which is equal or superior to 2,
U^{u+} is a cation,
u is an integer fixing the positive charge of the cation,
Y is as defined in claim 1 or 4 and
R groups are as previously described,
thus obtaining a mixture of monoesters of formula V:

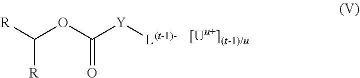

wherein R, Y, L, t, U, and u are as previously described,
d. Condensation of the mixture of monoesters of formula V obtained at step c. with an amine of formula R′R″R″′N, wherein R′, R″ and R′″ which may be the same or different, are hydrogen or a C₁ to C₄ alkyl group to obtain a mixture of compounds of formula VI:

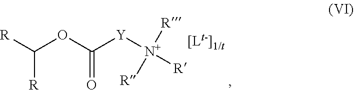

wherein R, R′, R″, R′″, Y, L and t are as previously described,
e. Optionally a step of anion exchange by contacting the mixture of compounds of formula VI obtained at step d. with a salt of formula [U′^{u′+}]_{n/u′}Xⁿ⁻ in order to substitute L^{t-} by Xⁿ⁻ when L^{t-} is different from Xⁿ⁻, X and n being as defined in any one of the preceding claims and U′^{u′+} is a cation, u′ is an integer fixing the positive charge of the cation, and
f. Recovering the mixture of compounds of formula I as defined above.

Further details on the process are given below.

### Process for Synthesis of the Mixture of Compounds of Formula I:

a. Piria Ketonization

The basic reaction in the first step is:

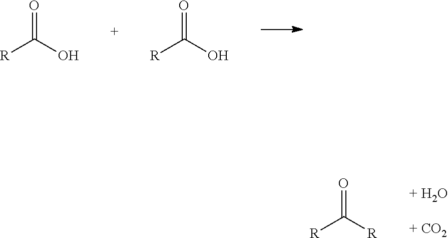

### Obtaining a Mixture of Internal Ketones of Formula II

R groups have the same meaning as defined above.

This reaction is described in U.S. patent Ser. No. 10/035,746, WO 2018/087179 and WO 2018/033607 to which reference is made for further details.

b. Hydrogenation

The internal ketone mixture of formula II is then subjected to hydrogenation which can be carried out under standard conditions known to the skilled person for hydrogenation reactions:

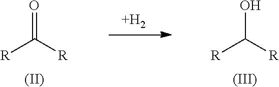

The hydrogenation reaction is conducted by contacting the internal ketone mixture of formula II with hydrogen in an autoclave reactor at a temperature ranging from 15° C. to 300° C. and at a hydrogen pressure ranging from 1 bar to 100 bars. The reaction can be conducted in the presence of an optional solvent but the use of such solvent is not mandatory and the reaction can also be conducted without any added solvent. Examples of suitable solvents include: methanol, ethanol, isopropanol, butanol, THF, methyl-THF, hydrocarbons, water or mixtures thereof. A suitable catalyst based on a transition metal should be employed for this reaction. Examples of suitable catalysts include: heterogeneous transition metal based catalysts such as for example supported dispersed transition metal based catalysts or homogeneous organometallic complexes of transition metals. Examples of suitable transition metals include: Ni, Cu, Co, Fe, Pd, Rh, Ru, Pt, Ir. Examples of suitable catalysts include: Pd/C, Ru/C, Pd/Al₂O₃, Pt/C, Pt/Al₂O₃, Raney Nickel, Raney Cobalt etc. At the end of the reaction, the desired alcohol mixture of formula III can be recovered after appropriate work-up. The skilled person is aware of representative techniques. Details of this process step can be found in U.S. patent Ser. No. 10/035,746 to which reference is made here.

The skilled person will select suitable reaction conditions based on his professional experience and taking into account the specific target compound to be synthesized. Accordingly, no further details need to be given here.

c. Esterification

The esterification of the above obtained alcohols mixture of formula III can thereafter be achieved by reacting said alcohols mixture of formula III with a carboxylic acid reagent of formula IV to obtain a mixture of monoester compounds of formula V:

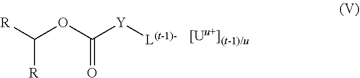

in accordance with the following scheme:

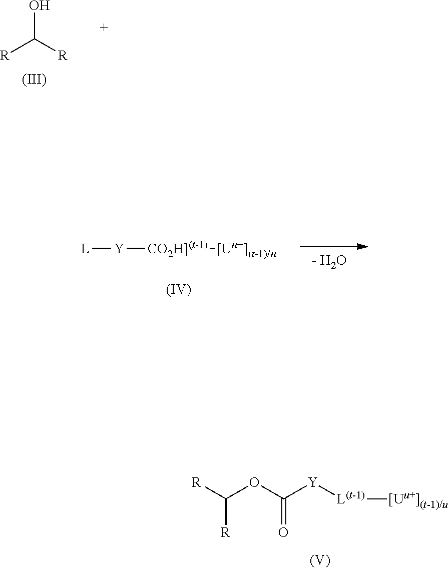

wherein, wherever present in the above compounds,
L is a leaving group,
t is an integer which is equal to 1 or which is equal or superior to 2,
U^{u+} is a cation,
u is an integer fixing the positive charge of the cation, and
R and Y are as previously described.

The esterification is performed by contacting the alcohol mixture of formula V with a carboxylic acid reagent of formula IV:

[L-Y—CO₂H]^{(t-1)}—[U^{u+}]_{(t-1)/u} (IV)

wherein L, Y, t, U^{u+} and u are as previously described.

When t is equal to 1, no cation is present. Alternatively the esterification reaction is performed by contacting the alcohol with a carboxylic acid of formula:

L-Y—CO₂H

In the case the leaving group L already carries a negative charge in the carboxylic acid reagent (this is the case when (t−1) is equal or superior to 1, i.e. when t is equal or superior to 2), a cation noted U^{u+} (with u preferably being 1, 2 or 3, more preferably 1) must be present in the reactant to ensure the electroneutrality. This cation may e.g. be selected from H⁺, alkaline metal cations (e.g. Na⁺ or K⁺), alkaline earth metal cations (e.g. Ca²⁺), Al³⁺ and ammonium, to mention only a few examples.

The nature of the leaving group L is not particularly limited provided the next reaction step (i.e. amine condensation, as will be detailed later on) can occur. The leaving group L is advantageously a nucleofuge group. It can be notably chosen from:
a halogen,
a (hydrocarbyloxysulfonyl)oxy group of formula R^{a}—O—SO₂—O— wherein R^{a} denotes a C₁-C₂₀ hydrocarbyl group which can be optionally halogenated,
a (hydrocarbylsulfonyl)oxy group of formula R^{a}—SO₂—O— wherein R^{a} denotes a C₁-C₂₀ hydrocarbyl group which can be optionally halogenated (such as in CF₃—SO₂—O—), and
an oxysulfonyloxy group of formula ⁻O—SO₂—O— (which is a leaving group L already carrying one negative charge on a terminal oxygen atom).

The hydrocarbyl group R^{a}, wherever present in here before formulae, can be notably an aliphatic group or an optionally substituted aromatic group such as phenyl or p-tolyl. The aliphatic group R^{a} is usually a C₁-C₆ alkyl group, which can be linear or ramified; it is often a linear C₁-C₄ alkyl, such as methyl, ethyl or n-propyl.

The leaving group L is preferably chosen from:
a halogen, such as fluorine, chlorine, bromine or iodine,
a (hydrocarbylsulfonyl)oxy group of formula R^{a}—SO₃— wherein R^{a} denotes a C₁-C₂₀ hydrocarbyl group, such as CH₃—SO₃— and
an oxysulfonyloxy group of formula ⁻O—SO₂—O—.

An example for a compound with t equal to 1 is CH₃—O—SO₃—CH₂—COOH which can be designated as 2-((methoxysulfonyl)oxy)acetic acid. Further examples of compounds in which t is equal to 1 and thus no cation is present, include: chloroacetic acid, bromoacetic acid and 2-chloropropionic acid. Chloroacetic acid is the preferred reagent of formula IV.

An example for t being equal to 2 is sodium carboxymethylsulfate acid in which [L-Y—COOH]^{(t-1)-}[U^{u+}]_{(t-1)/u} is [O—SO₂—O—CH₂—COOH]⁻[Na⁺].

The reaction conducted during esterification step c. can be conducted in the presence of a solvent. However the presence of such solvent is not mandatory and the reaction can be also conducted without any added solvent. As example of suitable solvents one can mention: toluene, xylene, hydrocarbons, DMSO, Me-THF, THF or mixtures thereof.

The reaction is advantageously conducted under an inert atmosphere, such as a nitrogen or rare gas atmosphere. An argon atmosphere is an example of a suitable inert atmosphere.

The reaction can be conducted in the absence of any catalyst. A catalyst can also be employed during the reaction and suitable catalysts are Bronsted or Lewis acid catalysts. Preferred examples of catalysts include: H₂SO₄, para-toluenesulfonic acid, methanesulfonic acid, trifluoromethanesulfonic acid, HCl, or heterogeneous acidic resins such as Amberlite® resins, AlCl₃, FeCl₃, SnCl₄, etc.

The total number of moles of the carboxylic acid reagent of formula IV which is contacted with the alcohol of formula III during the whole course of the reaction is advantageously no less than half of the total number of moles of alcohol; it is preferably at least as high as the total number of moles of alcohol, and it is more preferably at least twice higher than the total number of moles of alcohol. Besides, the total number of moles of carboxylic acid reagent which is contacted with the alcohol during the whole course of the reaction is advantageously at most ten times higher than the total number of moles of alcohol.

The reaction advantageously takes place in a reactor where the alcohol is in molten state. It has also been found advantageous that the reaction takes place in a reactor where the carboxylic acid reagent of formula IV is in molten state. Preferably, the reaction takes place in a reactor where both the alcohol and the carboxylic acid reagent are in molten state.

The esterification reaction can be conducted at a temperature ranging generally from about 20° C. to about 200° C. in the presence of an optional solvent. To allow for a sufficient reaction rate, the reaction is preferably conducted at a temperature which is of at least 60° C., more preferably at least 80° C., still more preferably at least 100° C. On the other hand, the Applicant has surprisingly found that conducting the reaction at a high temperature resulted in the formation of internal olefins as dehydration by-products and colour build-up. Accordingly, the reaction is conducted at a temperature which is preferably below 180° C., more preferably below 160° C. and still more preferably of at most 150° C.

The whole reaction can be conducted at atmospheric pressure or at subatmospheric pressure to assist water removal and to drive the equilibrium toward completion. It is preferably conducted at atmospheric pressure or under vacuum, that is to say at a pressure from 10 kPa to the atmospheric pressure (about 1 atm=101.325 kPa). More preferably, it is conducted at atmospheric pressure.

At the end of the reaction, the desired mixture of monoester compounds of formula V, can be recovered after appropriate work-up and the skilled person is aware of representative techniques so that no further details need to be given here. For example, an appropriate work-up can consist on distilling the excess of carboxylic acid reagent under vacuum. Alternatively, the excess of carboxylic acid reagent can be removed by simple extraction of the crude organic mixture with an aqueous solution.

d. Amine Condensation

The mixture of monoester compounds of formula V can be converted into the mixture of compounds of formula VI through the following reaction scheme:

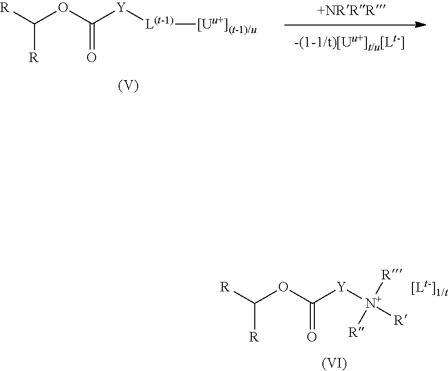

wherein R, R′, R″, R′″, Y, L, U, t and u are as described above.

The amine condensation reaction is performed by contacting the mixture of intermediate monoester compounds of formula V with ammonia or an amine of formula NR′R″R″

where R′, R″ and R′″, which may be the same or different, are hydrogen or a C₁ to C₄ alkyl group, and preferred R′, R″ and R′″ are exactly as above defined in connection with the ammonium compound of formula I.

The reaction can be conducted at a temperature ranging from 15° C. to 250° C. in the presence of a suitable solvent. As example of a suitable solvent one can mention: THF, Me-THF, methanol, ethanol, isopropanol, butanol, ethyl acetate, DMSO, toluene, xylene or their mixture. Alternatively the reaction can be also conducted in the absence of any added solvent.

During this reaction, there is a nucleophilic attack of ammonia or of the amine that substitutes L^{(t-1)-} in the monoester; L^{(t-1)-} plays the role of the leaving group. L^{t-} becomes then the counter-anion of the final ammonium compound. In the case the leaving group already carries a negative charge in the monoester (this is the case when (t−1) is equal or superior to 1 or when t is equal or superior to 2) there is also formation of a salt as the by-product of the reaction with the general chemical formula [U^{u+}]_{t/u}[L^{t-}].

e. Optional Anion Exchange

In a preferred embodiment L^{t-} is equal to Xⁿ⁻ (in other words X is equal to L), which means that compounds of formula VI are equal to compounds of formula I.

In this case the counterion Xⁿ⁻ of formula I is in fact coming from the leaving group L of previous steps. This is the case notably when Xⁿ⁻ is a halide, sulfate, hydrogensulfate, methanesulfonate, methosulfate, p-toluene sulfonate, dihydrogenphosphate, hydrogenphosphate, phosphate or organic carboxylate.

In another embodiment, the process of the invention comprises the step e. of anion exchange. For example when Xⁿ⁻ is a carbonate or bicarbonate, the mixture of compounds of formula I is obtained with an additional step e. of anion exchange in order to substitute L^{t-} by Xⁿ⁻.

For phosphate and carboxylate anions, both options are possible.

The anion exchange reaction during step e. can be conducted by contacting the mixture of compounds of formula VI obtained at the end of step d. (which are basically compounds of formula I but containing the anion L^{t-} instead of Xⁿ⁻) to be substituted with a salt of formula [U′^{u′+}]_{n/u′}Xⁿ⁻ in an appropriate solvent system allowing one of the product of the anion exchange reaction to precipitate out (either the new compound of formula I with Xⁿ⁻ as the counter-anion or the salt by-product [U′^{u′+}]_{t/u′}L^{t-}) in order to drive the equilibrium toward completion. U′^{u′+} is a cation, u′ is an integer fixing the positive charge of the cation.

This cation may e.g. be selected from H⁺, alkaline metal cations (e.g. Na⁺ or K⁺), alkaline earth metal cations (e.g. Ca²⁺), Al³⁺, Ag⁺ and ammonium, to mention only a few examples.

As example of solvents one can mention: water, methanol, ethanol, isopropanol, butanol, DMSO, acetone, aconitrile, ethyl acetate and their mixtures.

f. Recovering the Mixture of Compounds of Formula I

The final mixture of compounds of formula I can be recovered following an appropriate work-up known in the prior art.

A particularly preferred process for obtaining the mixture of compounds according to formula I is a process comprising the following steps:
a. decarboxylative ketonization of a mixture of fatty acids R—COOH, wherein R is a C₁₅ or C₁₇ aliphatic group and wherein said mixture of fatty acids comprising from 45 to 98% mol of R—COOH with R being a C₁₅ aliphatic group, in presence of a metal catalyst thus obtaining a mixture of internal ketones of formula II:

R—C(═O)—R (II),
wherein R groups which are as defined above,
b. Hydrogenation of the mixture of internal ketones of formula II obtained at step a. in presence of H₂ and a catalyst thus obtaining a mixture of secondary alcohols of formula III:

R—CH(OH)—R (III),
wherein R groups which are as defined above,
c. Esterification of the mixture of secondary alcohols of formula (III) obtained at step b. with a carboxylic acid reagent of formula (IV) being chloroacetic acid thus obtaining a mixture of monoesters of formula (V′)

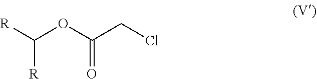

wherein R groups are as previously described,
d. Condensation of the mixture of monoesters of formula (V′) obtained at step c. with an amine of formula R′R″R′″N, wherein R′, R″ and R′″ are independently selected from hydrogen or a C₁ to C₄ alkyl group to obtain directly a mixture of compounds of formula (I′):

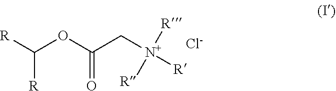

wherein R groups are as previously described.

This preferred process is salt free and chemical transformations can be easily performed.

Preferably the fabric conditioners of the present invention comprise more than 0.1 wt. % of the mixture of compounds having the formula I, more preferably more than 0.5 wt. %, most preferably more than 1 wt. % of the mixture of compounds having the formula I by weight of the composition. Preferably the fabric conditioners of the present invention comprise less than 40 wt. % of the mixture of compounds having the formula I, more preferably less than 30 wt. %, most preferably less than 20 wt. % of the mixture of compounds having the formula I by weight of the composition. Suitably the fabric conditioners comprise 0.1 to 40 wt. %, preferably 0.5 to 30 wt. % and more preferably 1 to 20 wt. % of the mixture of compounds having the formula I, by weight of the composition.

The fabric conditioners of the present invention preferably comprise 0.1 to 30 wt. % perfume ingredients, i.e. free perfume and/or perfume microcapsules. As is known in the art, free perfumes and perfume microcapsules provide the consumer with perfume hits at different points during the laundry process. It is particularly preferred that the fabric conditioners of the present invention comprise a combination of both free perfume and perfume microcapsules.

Preferably the fabric conditioners of the present invention comprise 0.1 to 20 wt. % perfume ingredients, more preferably 0.5 to 15 wt. % perfume ingredients, most preferably 1 to 10 wt. % perfume ingredients.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

The fabric conditioners of the present invention preferably comprise 0.1 to 15 wt. % free perfume, more preferably 0.5 to 8 wt. % free perfume.

Particularly preferred perfume components are blooming perfume components and substantive perfume components. Blooming perfume components are defined by a boiling point less than 250° C. and a Log P or greater than 2.5. Substantive perfume components are defined by a boiling point greater than 250° C. and a Log P greater than 2.5. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume components may be applied.

The fabric conditioners of the present invention preferably comprise 0.1 to 15 wt. % perfume microcapsules, more preferably 0.5 to 8 wt. % perfume microcapsules. The weight of microcapsules is of the material as supplied.

When perfume components are encapsulated, suitable encapsulating materials may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof.

Particularly preferred materials are aminoplast microcapsules, such as melamine formaldehyde or urea formaldehyde microcapsules.

Perfume microcapsules of the present invention can be friable microcapsules and/or moisture activated microcapsules. By friable, it is meant that the perfume microcapsule will rupture when a force is exerted. By moisture activated, it is meant that the perfume is released in the presence of water. The fabric conditioners of the present invention preferably comprise friable microcapsules. Moisture activated microcapsules may additionally be present. Examples of a microcapsules which can be friable include aminoplast microcapsules.

Perfume components contained in a microcapsule may comprise odiferous materials and/or pro-fragrance materials.

Particularly preferred perfume components contained in a microcapsule are blooming perfume components and substantive perfume components. Blooming perfume components are defined by a boiling point less than 250° C. and a Log P greater than 2.5. Preferably the encapsulated perfume compositions comprises at least 20 wt. % blooming perfume ingredients, more preferably at least 30 wt. % and most preferably at least 40 wt. % blooming perfume ingredients. Substantive perfume components are defined by a boiling point greater than 250° C. and a Log P greater than 2.5. Preferably the encapsulated perfume compositions comprises at least 10 wt. % substantive perfume ingredients, more preferably at least 20 wt. % and most preferably at least 30 wt. % substantive perfume ingredients. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a microcapsule. In the compositions for use in the present invention it is envisaged that there will be three or more, preferably four or more, more preferably five or more, most preferably six or more different perfume components in a microcapsule. An upper limit of 300 perfume components may be applied.

The microcapsules may comprise perfume components and a carrier for the perfume ingredients, such as zeolites or cyclodextrins.

The fabric conditioners of the present invention preferably comprise a fatty co-softener. These are typically present at from 0.1 to 20 wt. % and particularly at from 0.4 to 15 wt. %, preferably 1 to 15 wt. % based on the total weight of the composition.

In the context of this invention a fatty co-softener is considered to be a material comprising an aliphatic carbon chain. Preferably the carbon chain comprises more than 6 carbons, more preferably more than 8 carbons and preferably less than 30 carbons. The aliphatic chain may be saturated or unsaturated and may be branched or unbranched.

Preferred fatty co-softeners include fatty esters, fatty alcohols, fatty acids and combinations thereof. Fatty esters that may be employed include fatty monoesters, such as glycerol monostearate, fatty sugar esters and fatty acid mono-esters. Fatty acids which may be employed include hardened tallow fatty acid or hardened vegetable fatty acid (available under the trade name Pristerene™, ex Croda). Fatty alcohols which may be employed include tallow alcohol or vegetable alcohol, particularly preferred are hardened tallow alcohol or hardened vegetable alcohol (available under the trade names Stenol™ and Hydrenol™, ex BASF and Laurex™ CS, ex Huntsman). Preferably the fatty material is a fatty alcohol.

Preferably the fatty co-softener has a fatty chain length of C12 to C22, preferably C14 to C20.

The weight ratio of the softening active to the fatty co-softening agent is preferably from 10:1 to 1:2, more preferably 5:1 to 1:2, most preferably 3:1 to 1:2, e.g. 2:1 to 1:1.

When used in combination with tri-ethanol amine quaternary ester quats, fatty co-softeners are known to reduce the softening levels, however when combined with the softening actives described, surprisingly a softening benefit is demonstrated.

The fabric conditioners may further comprise a non-ionic surfactant. These are included to improve the solubility of the mixture of compounds. Suitable non-ionic surfactants include addition products of ethylene oxide and/or propylene oxide with fatty alcohols, fatty acids and fatty amines. Any of the alkoxylated materials of the particular type described hereinafter can be used as the non-ionic surfactant.

Suitable surfactants are substantially water soluble surfactants of the general formula (VII):

R—Y—(C₂H₄O)_{z}—CH₂—CH₂—OH (VII)

where R is selected from the group consisting of primary, secondary and branched chain alkyl and/or acyl hydrocarbyl groups; primary, secondary and branched chain alkenyl hydrocarbyl groups; and primary, secondary and branched chain alkenyl-substituted phenolic hydrocarbyl groups; the hydrocarbyl groups having a chain length of from 8 to about 25, preferably 10 to 20, e.g. 14 to 18 carbon atoms.

In the general formula for the ethoxylated non-ionic surfactant, Y is typically:

—O—, —C(O)O—, —C(O)N(R)— or —C(O)N(R)R—

in which R has the meaning given above for formula (VII), or can be hydrogen; and Z is at least about 8, preferably at least about 10 or 11.

Preferably the non-ionic surfactant has an HLB of from about 7 to about 20, more preferably from 10 to 18, e.g. 12 to 16. Genapol™ C200 (Clariant) based on coco chain and 20 EO groups is an example of a suitable non-ionic surfactant.

If present, the non-ionic surfactant is present in an amount from 0.01 to 10 wt. %, more preferably 0.1 to 5 wt. %, based on the total weight of the composition.

A class of preferred non-ionic surfactants include addition products of ethylene oxide and/or propylene oxide with fatty alcohols, fatty acids and fatty amines. These are preferably selected from addition products of (a) an alkoxide selected from ethylene oxide, propylene oxide and mixtures thereof with (b) a fatty material selected from fatty alcohols, fatty acids and fatty amines.

Suitable surfactants are substantially water soluble surfactants of the general formula (VIII):

R—Y—(C₂H₄O)_{z}—CH₂—CH₂—OH (VIII)

where R is selected from the group consisting of primary, secondary and branched chain alkyl and/or acyl hydrocarbyl groups (when Y═—C(O)O, R≠an acyl hydrocarbyl group); primary, secondary and branched chain alkenyl hydrocarbyl groups; and primary, secondary and branched chain alkenyl-substituted phenolic hydrocarbyl groups; the hydrocarbyl groups having a chain length of from 10 to 60, preferably 10 to 25, e.g. 14 to 20 carbon atoms.

In the general formula for the ethoxylated non-ionic surfactant, Y is typically:

—O—, —C(O)O—, —C(O)N(R)— or —C(O)N(R)R—

in which R has the meaning given above for formula (VIII), or can be hydrogen; and Z is at least about 6, preferably at least about 10 or 11.

Lutensol™ AT25 (BASF) based on C16:18 chain and 25 EO groups is an example of a suitable non-ionic surfactant. Other suitable surfactants include Renex 36 (Trideceth-6), ex Croda; Tergitol 15-S3, ex Dow Chemical Co.; Dihydrol LT7, ex Thai Ethoxylate ltd; Cremophor CO40, ex BASF and Neodol 91-8, ex Shell.

The fabric conditioners as described herein preferably comprise a rheology modifier. Rheology modifiers may be used to “thicken” or “thin” liquid compositions to a desired viscosity. The compositions preferably comprise 0.01 to 10 wt. % of the formulation, preferably 0.05 to 5 wt. % of the formulation, more preferably 0.1 to 2 wt. % of the formulation.

Suitable rheology modifiers are preferably polymeric materials. The rheology modifier may be synthetic alternatively the rheology modifier may be wholly or partly derived from natural sources such as cellulosic fibres (for example, microfibrillated cellulose, which may be derived from a bacterial, fungal, or plant origin, including from wood).

Naturally derived polymeric rheology modifiers may comprise hydroxyethyl cellulose, hydrophobically modified hydroxyethyl cellulose, carboxymethyl cellulose, polysaccharide derivatives and mixtures thereof. Polysaccharide derivatives may comprise pectine, alginate, arabinogalactan (gum Arabic), carrageenan, gellan gum, xanthan gum, guar gum and mixtures thereof.

Synthetic polymeric rheology modifiers may comprise polycarboxylates, polyacrylates, hydrophobically modified ethoxylated urethanes, hydrophobically modified non-ionic polyols and mixtures thereof. Polycarboxylate polymers may comprise a polyacrylate, polymethacrylate or mixtures thereof. Polyacrylates may comprise a copolymer of unsaturated mono- or di-carbonic acid and C₁-C₃₀ alkyl ester of the (meth)acrylic acid. Such copolymers are available from Noveon Inc. under the tradename Carbopol Aqua 30. Another suitable structurant is sold under the tradename Rheovis CDE, available from BASF.

Preferably the rheology modifier is selected from polyacrylates, polysaccharides, polysaccharide derivatives, or combinations thereof. Polysaccharide derivatives typically used as rheology modifiers comprise polymeric gum materials. Such gums include pectine, alginate, arabinogalactan (gum Arabic), carrageenan, gellan gum, xanthan gum and guar gum.

The rheology modifier may preferably be a cationic polymer. Cationic polymer refers to polymers having an overall positive charge. Cationic polymers may comprise non-cationic structural units, but the rheology modifier preferably have a net cationic charge.

Preferred synthetic rheology modifiers comprise may comprise: acrylamide structural units, methacrylate structural units, acrylate structural units, methacrylic acid units and combinations thereof.

The rheology modifier may preferably be cross-linked. Preferably the rheology modifier is crosslinked with 50 to 1000 ppm of a difunctional vinyl addition monomer cross-linking agent. Particularly preferred crosslinked polymers are cross-linked copolymers of acrylamide and methacrylate cross-linked with a difunctional vinyl addition monomer, such as methylene bisacrylamide. Preferred cationic cross-linked polymers are derivable from the polymerization of from 5 to 100 mole percent of cationic vinyl addition monomer, from 0 to 95 mole percent of acrylamide and from 50 to 1000 ppm of a difunctional vinyl addition monomer cross-linking agent. Particularly preferred polymers are copolymers of 20% acrylamide and 80% MADAM methyl chloride (MADAM: dimethyl amino ethyl methacrylate) cross-linked with from 450 to 600 ppm of methylene bisacrylamide.

In one embodiment, the rheology modifier may be a cationic acrylamide copolymer obtained by Hofmann rearrangement in aqueous solution in the presence of an alkali and/or alkaline earth hydroxide and an alkali and/or alkaline earth hypohalide, on a base copolymer comprising:
at least 5 mole % of a non-ionic monomer selected from the group consisting of acrylamide, methacrylamide, N,N-dimethylacrylamide, acrylonitrile, and combinations thereof; and
at least one comonomer selected from the group consisting of unsaturated cationic ethylenic comonomer, non-ionic comonomer, or combinations thereof, provided that the non-ionic comonomer is not acrylamide, methacrylamide, N,N-dimethylacrylamide, or acrylonitrile.

The cationic copolymer thus obtained has a desalination coefficient (Cd) of greater than 0.6 (e.g., greater than 0.65 and greater than 0.7). Cd is calculated as Real polymeric active matter (% by weight of the copolymer)×Polymer filler density Conductivity of the solution containing 9% of active matter. See also U.S. Pat. No. 8,242,215.

The unsaturated cationic ethylenic comonomer can be selected from the group consisting of dialkylaminoalkyl(meth)acrylamide monomers, diallylamine monomers, methyldiallylamine monomers, and quaternary ammonium salts or acids thereof, such as dimethyldiallylammonium chloride (DADMAC), acrylamidopropyltrimethyl-ammonium chloride (APTAC), methacrylamidopropyltrimethylammonium chloride (MAPTAC). Examples of the non-ionic comonomer are N-vinyl acetamide, N-vinyl formamide, N-vinylpyrrolidone, vinyl acetate, and combinations thereof.

The base copolymer is preferably branched in the presence of a branching agent selected from the group consisting of methylene bisacrylamide, ethylene glycol di-acrylate, polyethylene glycol dimethacrylate, diacrylamide, cyanomethylacrylate, vinyloxyethylacrylate, vinyloxyethylmethacrylate, triallylamine, formaldehyde, glyoxal, and a glycidylether type compound. More examples of the cationic acrylamide copolymers can be found in U.S. Pat. No. 8,242,215.

Examples of suitable rheology modifiers are commercially available from SNF Floerger under the trade names Flosoft FS 200, Flosoft FS 222, Flosoft FS 555, and Flosoft FS 228 and are commercially available from BASF under the trade names Rehovis CDE and Rehovis FRC. See also WO 2007141310, US 20060252668, and US 20100326614.

The fabric conditioners may comprise other ingredients of fabric softener liquids as will be known to the person skilled in the art. Among such materials there may be mentioned: antifoams, insect repellents, shading or hueing dyes, preservatives (e.g. bactericides), pH buffering agents, perfume carriers, hydrotropes, anti-redeposition agents, soil-release agents, polyelectrolytes, anti-shrinking agents, anti-wrinkle agents, anti-oxidants, dyes, colorants, sunscreens, anti-corrosion agents, drape imparting agents, anti-static agents, sequestrants and ironing aids. The products of the invention may contain pearlisers and/or opacifiers. A preferred sequestrant is HEDP, an abbreviation for Etidronic acid or 1-hydroxyethane 1,1-diphosphonic acid.

In one aspect of the present invention, is a method of softening fabrics, wherein a fabric conditioner as described herein is added to the rinse stage of laundering said fabrics. The laundry process may be performed by hand or a washing machine.

Preferably the fabric is treated with a 10 to 100 ml dose of fabric conditioner for a 3 to 7 kg load of clothes. More preferably, 10 to 80 ml for a 3 to 7 kg load of clothes.

The composition as described herein have improved softening and biodegradability. Accordingly, in once aspect of the present invention is provided a use of the fabric conditioners as described herein to provide softening to fabrics. Softening may be assessed by a panel or using an instrument such as a PhabrOmeter® ex. Nu Cybertek, Inc.

### EXAMPLES

### Example 1

### Synthesis of a Mixture Compounds of Formula I from a C₁₆-C₁₈ Fatty Acids Mixture with C₁₆:C₁₈=33.7:65.3 wt % (or in Other Words Mixture of R—COOH with R=C₁₅:R=C₁₇, =33.7:65.3 wt %)

All the reactions are conducted under an inert argon atmosphere.
Step a and b: Piria Ketonization and Hydrogenation The 2 first steps (Piria and hydrogenation) have been performed according to the protocol described in example 12 of the published patent application WO 2020/254337.
Step c: Secondary Alcohol Esterification with Chloroacetic Acid

In a three necked 500 mL round bottom flask equipped with a magnetic stirring devise, a heater, a temperature probe, a distillation apparatus connected to a receiver flask are added:
50 g (0.102 mole, 1 eq.) of C₃₁-C₃₅ mixture of secondary alcohols.
39.1 g of chloroacetic acid (0.41 mole, 4 eq.) The reaction mixture is then heated to 120° C. and stirring is started (900 rpm stirring rate) once the reaction mixture has completely melted (around 105° C.).

The reaction mixture is then allowed to stir at 120° C. and reaction progress is followed up thanks to 1H NMR spectroscopy.

After 1 h stirring at 120° C., NMR analysis shows a conversion level of 82%. In order to effectively remove water that is co-generated during the reaction and to displace the equilibrium toward esterification completion, a slight vacuum is applied to the reactor (800 mbar).

After an additional 2 h of stirring at 120° C. under 800 mbar, NMR analysis of the reaction crude shows a conversion level of 96%.

Reactor pressure is then decreased down to 30 mbar and the temperature of the reaction medium is further increased to 140° C. in order to distillate out the excess of chloroacetic acid.

Distillation at 140° C., 30 mbar is carried out until complete disappearance of chloroacetic acid as evidenced by 1 H NMR analysis of the crude (<0.3 mol % of remaining chloroacetic acid in the crude).

At the end of the reaction, the pressure is re-established to 1 atm. and the reaction medium is allowed to cool down to room temperature. 56.7 g of product is recovered as a beige wax with the following composition: 98.9 wt. % of mixture of chloroacetate esters, 1 wt. % of starting mixture of fatty alcohols, 0.04 wt. % of remaining chloroacetic acid.

The esterification yield taking into account purity is 97%.

The crude product is then engaged to the next quaternization stage.

¹H NMR (CDC₃, 400 MHz) δ (ppm): 4.93 (quint, J=6.0 Hz, 1H), 4.01 (s, 2H), 1.64-1.46 (m, 4H), 1.45-1.05 (m, 57 H (average number)), 0.86 (t, J=6.8 Hz, 6H).

¹³C NMR (CDCl₃, 101 MHz) δ (ppm): 167.32, 77.21, 41.37, 34.17, 32.16, 29.93, 29.90, 29.87, 29.79, 29.72, 29.69, 29.60, 25.42, 22.92, 14.33.

Step d: Chioroacetate Ester Quaternization with Trimethylamine In a 1 L double-jacketed reactor equipped with a mechanical stirrer (propeller with four inclined plows), a temperature probe, a condenser and which is connected to 2 consecutive traps containing respectively an aqueous solution of HCl (0.1 M) and activated charcoal are added:
56 g (0.099 mole, 1 eq.) of mixture of chloroacetate esters obtained from step c.
212 mL (180.6 g, 0.397 mole, 4 eq.) of trimethylamine/THF solution (13 wt %, 2 mol/L).

The reaction mixture is then allowed to stir at 40° C. (700 rpm stirring rate) and the reaction progress is followed thanks to 1H NMR spectroscopy.

After 2 h stirring at 40° C., the conversion level of mixture of chloroacetate esters is around 66%.

After 4 h stirring at 40° C., the conversion level increased to 85%.

In order to increase the reaction kinetic, the temperature of the reaction medium is increased further to 55° C. and after 2 additional hours of stirring at 55° C., the conversion level has reached 94%.

The reaction mass is then allowed to stir at 55° C. for additional 6 h00 in order to complete the reaction.

At this stage the reaction crude composition is: 98 mol % of mixture of glycine betaine esters of formula I and 0.7 mol % of the starting mixture of chloroacetate esters.

The reaction medium is then allowed to cool down to room temperature and all the volatiles are removed under vacuum to afford 61.41 g of crude material as a beige wax with the following composition: 98.2 wt % of mixture of glycine betaine esters of formula I, 0.9 wt % of mixture of fatty secondary alcohols and 0.8 wt % of mixture of chloroacetate esters corresponding to a yield of 97.4% taking into account the purity.

¹H NMR (CD30D, 400 MHz) δ (ppm): 5.02 (quint, J=6.0 Hz, 1H), 4.41 (s, 2H), 3.35 (s, 9H), 1.68-1.52 (m, 4H), 1.50-1.05 (m, 57 H (average number)), 0.87 (t, J=7.2 Hz, 6H). ¹³C NMR (CD30D, 101 MHz) 5 (ppm): 165.46, 78.81, 63.98, 54.43, 34.59, 32.83, 30.56, 30.53, 30.49, 30.44, 30.34, 30.24, 26.07, 23.53, 14.54.

### Example 2) Synthesis of a Mixture of Compounds of Formula I from a C₁₆-C₁₈ Fatty Acids Mixture with C₁₆:C₁₈=60.9:38.2 wt % (or in Other Words Mixture of R—COOH with R=C₁₅:R=C₁₇=60.9:38.2 wt %)

All the reactions are conducted under an inert argon atmosphere.

### Steps a and b: Piria Ketonization and Hydrogenation

The 2 first steps (Piria and hydrogenation) have been performed according to the protocol described in example 13 of the published patent application WO 2020/254337.

Step c: Secondary Alcohol Esterification with Chloroacetic Acid

In a three necked 500 mL round bottom flask equipped with a magnetic stirring devise, a heater, a temperature probe, a distillation apparatus connected to a receiver flask are added:
82 g (0.173 mole, 1 eq.) of C₃₁-C₃₅ mixture of secondary alcohols.
66.2 g of chloroacetic acid (0.693 mole, 4 eq.) The reaction mixture is then heated to 120° C. and stirring is started (1200 rpm stirring rate) once the reaction mixture has completely melted.

A slight vacuum (800 mbar) is applied in order to remove water that is co-produced by the reaction and to displace the equilibrium toward esterification completion.

The reaction mixture is allowed to stir at 120° C., 800 mbar during 3 h40 and reaction progress is followed up thanks to 1H NMR spectroscopy.

After 3 h reaction time, NMR analysis shows a conversion level of 96%.

The pressure is then decreased down to 10 mbar in order to distillate out chloroacetic acid excess and the distillation is carried out until complete disappearance of chloroacetic acid as evidenced by 1 H NMR analysis of the crude (<0.3 mol % of remaining chloroacetic acid in the crude).

At the end of the distillation, the pressure is re-established to 1 atm. and the reaction medium is allowed to cool down to room temperature. 95 g of product is recovered as a beige wax with the following composition: 98.3 wt. % of mixture of chloroacetate esters and 1.7 wt. % of starting mixture of fatty alcohols.

The esterification yield taking into account purity is 98%.

The crude product is then engaged into the next quaternization stage.

¹H NMR (CDCl₃, 400 MHz) δ (ppm): 4.93 (quint, J=5.6 Hz, 1H), 4.01 (s, 2H), 1.62-1.46 (m, 4H), 1.33-1.16 (m, 54.8 H (average number)), 0.86 (t, J=6.8 Hz, 6H).

Step d: Chioroacetate Ester Quaternization with Trimethylamine

In a 1 L double-jacketed reactor equipped with a mechanical stirrer (propeller with four inclined plows), a temperature probe, a condenser and which is connected to 2 consecutive traps containing respectively an aqueous solution of HCl (0.1 M) and activated charcoal are added:
95 g (98.3 wt. % purity, 0.17 mole, 1 eq.) of a mixture of chloroacetate esters obtained from step c.
364 mL (309 g, 0.68 mole, 4 eq.) of trimethylamine/THF solution (13 wt. %, ˜ 2 mol/L).

The reaction mixture is then allowed to stir at 55° C. (1200 rpm stirring rate) and the reaction progress is followed thanks to 1H NMR spectroscopy.

After 3 h 30 mins stirring at 55° C., the conversion level of mixture of chloroacetate esters is around 87%.

After 5 h 45 mins stirring at 55° C., the conversion level increased to 97%.

The reaction mass is then allowed to stir at 55° C. for additional 6 h in order to complete the reaction.

At this stage the reaction crude composition is: 98 mol % of mixture of glycine betaine esters of formula I and 0.2 mol % of the starting mixture of chloroacetate esters.

The reaction medium is then allowed to cool down to room temperature and all the volatiles are removed under vacuum to afford 103 g of crude material as a beige wax with the following composition: 98.3 wt. % of mixture of glycine betaine esters of formula I, 1.5 wt. % of mixture of fatty secondary alcohols and 0.2 wt. % of mixture of chloroacetate esters corresponding to a yield of 98%.

¹H NMR (CD30D, 400 MHz) δ (ppm): 4.97 (quint, J=6.0 Hz, 1H), 4.38 (s, 2H), 3.36 (s, 9H), 1.65-1.46 (m, 4H), 1.45-1.05 (m, 54.8 H (average number)), 0.84 (t, J=6.8 Hz, 6H). ¹³C NMR (CD30D, 101 MHz) 5 (ppm): 164.81, 78.67, 63.64, 54.28, 34.12, 32.36, 30.11, 30.08, 30.05, 30.02, 29.90, 29.81, 29.78, 25.66, 23.10, 14.38.

### Biodegradability Assessment:

Readily biodegradability of the test substances have been measured according to the 301 F OECD protocol.

A measured volume of inoculated mineral medium, containing a known concentration of the test substance in order to reach about 50 to 100 mg ThOD/I (Theorical Oxygen Demand) as the nominal sole source of organic carbon, is stirred in a closed flask (Oxitop™ respirometric flask) at a constant temperature (20±2° C.) for up to 28 days. Oxitop™ respirometric bottles were used in this test in order to access the biodegradability of the test samples: sealed culture BOD flasks were used at a temperature of 20±2° C. during 28 days.

Evolved carbon dioxide is absorbed by pellets of Natrium or Potassium hydroxide present in the head space of the bottle. The amount of oxygen taken up by the microbial population (=oxygen consumption expressed in mg/I) during biodegradation process (biological oxidation of the test substance) will decrease the pressure of the head space (Δ P measured by the pressure switch) and will mathematically be converted in mg O₂ consumed/litre. Inoculum corresponds to a municipal activated sludge washed in mineral medium (ZW media) in order to decrease the DOC (Dissolved Oxygen Carbon) content. Control solutions containing the reference substance sodium acetate and also toxicity control (test substance+reference substance) were used for validation purposes.

Reference substance, sodium acetate, has been tested in one bottle (at a nominal concentration of 129 mg/I corresponding to 100 mg ThOD/I in order to check the viability of the inoculum. Toxicity control corresponds to the mixture of the substance reference and the test substance; it will check if the test substance is toxic towards the inoculum (if so, the test has to be redone at a lower test substance concentration, if feasible regarding the sensitivity of the method).

As the test substances are for a majority of them not very soluble in water (if some are soluble in water, their metabolite after hydrolysis containing the alkyl chain is often very low soluble in water), we used a specific protocol named the “emulsion protocol”. This protocol enables us to increase the bioavailability of the poorly water soluble substance in the aqueous phase where we have the inoculum.

Emulsion protocol consists of adding the test substance in the bottle through a stock solution made in an emulsion.

Emulsion is a 50/50 v/v mixture of a stock solution of the test substance dissolved in a non biodegradable surfactant containing aqueous solution (Synperonic PE 105 at 1 g/l) and then mixed with a mineral silicone oil AR 20 (Sigma).

The first dissolution of the test substance in the non biodegradable surfactant containing aqueous solution often required magnetic stirrer agitation followed by ultrasonication.

Once the dissolution is made, we mix the aqueous solution with a mineral silicone oil at a 50/50 volume/volume ratio. This emulsion is maintained by magnetic stirrer agitation and is sampled for an addition in the corresponding bottle in order to reach the required test substance concentration.

2 emulsion controls, are run in parallel during the test in order to remove their value from the emulsion bottle containing the test substance added through the emulsion stock solution.

The results of the biodegradability tests are summarized in the table 1 below:

TABLE 1
biodegradability

| Mixture of Compounds of | |
|---|---|
| formula I: | Biodegradability rate vs DThO after 28 days |
| Example 1 - comparative | 50.4% (average over 2 replicates) |
| Example 2 - invention | 67.5% (average over 3 replicates) |

The mixture of quaternary ammonium compounds of formula I derived from the C₁₆-C₁₈ fatty acids mixture with C₁₆:C₁₈=60.9:38.2 wt. % displays a final biodegradation rate of 67.5% and can be therefore considered as readily biodegradable. On the other hand the mixture of quaternary ammonium compounds of formula I derived from the C₁₆-C₁₈ fatty acids mixture with C₁₆:C₁₈=33.7:65.3 wt. % displays a lower biodegradation rate of 50.4% and cannot be considered as readily biodegradable.

These results show that the hydrocarbon chain length distribution in the final mixture of compounds of formula I (and therefore in the starting mixture of fatty acids) has an important impact on the biodegradability.

Additional mixtures of quaternary ammonium compounds of formula I have been prepared by mixing the mixtures obtained in example 1 and 2 in two different ratios (one according to the invention and the other as comparative) and the biodegradability assessment has been performed according to the same method as described above. The results are indicated in Table 2 below.

TABLE 2

| Mix composition | | | | Corresponding wt % | | |
|---|---|---|---|---|---|---|
| (in weight % of mixture | mol % chain length | | | fatty acid distribution | | |
| of Example 1:mixture | distribution | | | (in mol %) | | % Biodeg |
| of Example 2) | C₃₁ | C₃₃ | C_{35 . . .} | C₁₆ | C₁₈ | vs DThO |
| Example 3 - | 18 | 46 | 36 | 39 | 61 | 57% |
| Comparative: 83:17 | | | | (42) | (58) | |
| Example 4 - | 23 | 46 | 31 | 43 | 57 | 61% |
| Invention: 67:33 | | | | (46) | (54) | |

Readily biodegradable (meaning in this case BOD>60% vs. DThO after 28 days) for the mixture of quaternary ammonium compounds of formula I is obtained for a C₃₁ content in the hydrocarbon chain length distribution≤20 mol % (C₃₅ content≤31 mol %) corresponding to a C₁₆ fatty acid content in the starting fatty acid material 45 mol % for a C₁₆-C₁₈ fatty acid mixture raw material.

In other words, readily biodegradation is obtained for an average hydrocarbon chain length≤C₃₃ in the mixture of quaternary ammonium compounds of formula I, i.e. wherein both R groups are C₁₇ or C₁₅.

1. A fabric conditioner composition comprising:
a) a mixture of compounds having the formula I: 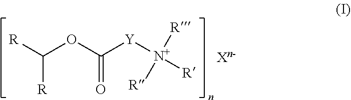
wherein each R group, is independently selected from a C₁₅ or C₁₇ aliphatic group,
Y is a divalent C₁-C₆ aliphatic group,
R′, R″ and R′″ are independently selected from hydrogen or a C₁ to C₄ alkyl group,
Xⁿ⁻ is a counter-anion selected from the group consisting of:
i. a halide (n=1),
ii. a hydrocarbylsulfate anion of formula R^{a}—O—SO₂—O⁻ wherein R^{a} denotes a C₁-C₂₀ hydrocarbyl group which can be optionally halogenated (n=1),
iii. a hydrocarbylsulfonate anion of formula R^{a}—SO₂—O⁻ wherein R^{a} denotes a C₁-C₂₀ hydrocarbyl group which can be optionally halogenated (n=1),
iv. a sulfate anion of formula SO₄²⁻ (n=2),
v. a hydrogensulfate (or bisulfate) anion of formula HSO₄— (n=1),
vi. a carbonate anion of formula CO₃²⁻ (n=2),
vii. a hydrogencarbonate (or bicarbonate) anion of formula HCO₃— (n=1),
viii. a dihydrogenphosphate anion of formula H₂PO₄— (n=1),
ix. a hydrogenphosphate anion of formula HPO₄²⁻ (n=2),
x. a phosphate anion of formula PO₄³⁻ (n=3),
xi. an organic carboxylate anion of formula Rₐ—CO₂— wherein Ra denotes a C1-C20 hydrocarbyl group which can be optionally halogenated substituted by a heteroatom containing group (n=1),
xii. and mixtures thereof,
n is an integer which is equal to 1, 2 or 3, depending on the nature of the counter-anion; and
said mixture comprising from 20 to 95% mol of compounds of formula I wherein both R are C₁₅ aliphatic groups.

2. A The fabric conditioner according to claim 1, wherein the R groups of the mixture of compounds are C₁₅ or C₁₇ alkyl groups and said mixture comprises from 20 to 95% mol of compounds of formula I wherein both R groups are C₁₅ alkyl groups.

3. The fabric conditioner according to claim 1, wherein the R groups of the mixture of compounds are C₁₅ or C₁₇ linear alkyl groups and said mixture comprises from 20 to 95% mol of compounds of formula I wherein both R groups are C₁₅ linear alkyl groups.

4. The fabric conditioner according to claim 1, wherein the Y groups of the mixture of compounds is are a methylene group.

5. A fabric conditioner according to claim 1, wherein the R′, R″ and R′″ of the mixture of compounds are methyl.

6. A fabric conditioner according to claim 1, wherein the Xⁿ⁻ of the mixture of compounds is a halide with n=1.

7. The fabric conditioner according to claim 1, wherein the mixture of compounds comprises from 20 to 60% mol of compounds of formula I and wherein both R groups are C₁₅ aliphatic groups.

8. The fabric conditioner according to claim 1, wherein the mixture of compounds comprises:
a. from 20 to 95% mol of compounds of formula I wherein both R groups are C₁₅ linear alkyl groups,
b. from 4.9 to 50% mol of compounds of formula I wherein one R group is a C₁₅ linear alkyl group and the other R group is a C₁₇ linear alkyl group, and
c. from 0.1 to 31% mol of compounds of formula I wherein both R groups are C₁₇ linear alkyl groups.

9. The fabric conditioner according to claim 1, wherein the mixture of compounds comprises less than 5% mol of compounds of formula I and further wherein at least one of the R groups, are independently selected from C7 to C13 aliphatic group and/or C19 to C21 aliphatic group.

10. The fabric conditioner according to claim 1, wherein the composition further comprises perfume ingredients.

11. The fabric conditioner according to claim 1, wherein the composition further comprises a co-softening agent.

12. The fabric conditioner according to claim, wherein the composition further comprises a non-ionic surfactant.

13. The fabric conditioner according to any preceding claim 1, wherein the composition further comprises a rheology modifier.

14. A method of softening fabrics, wherein a fabric conditioner according to claim 1 is added to a rinse stage when laundering said fabrics.

15. The method of softening fabrics according to claim 14, wherein the method further comprises the step of adding an antifoam, insect repellent, shading or hueing dye, preservative, pH buffering agent, perfume carrier, hydrotrope, anti-redeposition agent, soil-release agent, polyelectrolyte, anti-shrinking agent, anti-wrinkle agent, anti-oxidant, dye, colorant, sunscreen, anti-corrosion agent, drape imparting agent, anti-static agent, sequestrant, ironing aid, pearliser, opacifier or a mixture thereof.
